(19) United States
(12) Patent Application Publication
(10) Pub. No.: US 2003/0052848 A1
(43) Pub. Date: Mar. 20, 2003

(54) Signal transmission circuit, solid-state imaging device, camera and liquid crystal display

(75) Inventor: Takumi Yamaguchi, Kyoto-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd, Kadoam-shi (JP)

(21) Appl. No.: 10/251,602

(22) Filed: Sep. 19, 2002

(30) Foreign Application Priority Data
Sep. 20, 2001 (JP) 2001-287683
Oct. 26, 2001 (JP) 2001-239787
Nov. 28, 2001 (JP) 2001-362934

(51) Int. Cl. G09G 3/36

(52) U.S. Cl. 345/87

(57) ABSTRACT

A signal transmission circuit that can be operated stably even when a power supply of the circuit has a reduced voltage is provided as a shift register. A positive-side terminal (a node N11) of a bootstrap capacitor (C1) is connected to a gate of a charge transistor (T21) in a unit circuit of a subsequent stage. Consequently, the gate of the charge transistor in the unit circuit of the subsequent stage always is supplied with a high voltage of the positive-side terminal of the bootstrap capacitor in the unit circuit of its preceding stage, and therefore, a bootstrap capacitor (C2) in the unit circuit of the subsequent stage can be charged reliably up to a power supply voltage VDD even when the power supply voltage VDD is lowered.

### BACKGROUND OF THE INVENTION

1. Field of the Invention

The present invention relates to a signal transmission circuit that is applied to a shift register for driving a MOS image sensor or a liquid crystal display and can be driven at low voltages.

2. Description of Related Art

FIG. 9 is a circuit diagram showing a structural example of a conventional signal transmission circuit. For convenience in description, FIG. 9 shows only four stages out of a multiple-stage structure. This signal transmission circuit includes output transistors T12, T22, T32, T42 to their subsequent stages, bootstrap capacitors C1, C2, C3, C4, charge transistors T11, T21, T31, T41 for charging these bootstrap capacitors respectively, and discharge transistors T13, T14, T23, T24, T33, T34, T43, T44. A power supply voltage VDD, drive pulses V1, V2 and a start pulse VST are supplied to the signal transmission circuit.

The following is a description of an operation of a conventional signal transmission circuit constituted as above.

When the start pulse VST reaches a logic “High” level, the charge transistor T11 of a first stage is turned on, and the bootstrap capacitor C1 is charged up to the power supply voltage VDD. When the charge voltage of the bootstrap capacitor C1 exceeds a threshold voltage level of the output transistor T12, the output transistor T12 of the first stage is turned on.

Thereafter, when the drive pulse V1 at the logic “High” level is inputted to a drain of the output transistor T12, a voltage of the drive pulse V1 and a potential difference between both terminals of the bootstrap capacitor C1 are added together and applied to a gate of the output transistor T12. When a gate potential of the output transistor T12 becomes greater than the potential of the drive pulse V1, the drive pulse V1 is outputted from a node N12 as an output pulse OUT1 for use.

At the same time, the voltage of the node N12 is applied to a gate of the charge transistor T21 of a second stage, so that the transistor T21 is turned on. The bootstrap capacitor C2 is charged up to the power supply voltage VDD, and when the charge voltage of the bootstrap capacitor C2 exceeds the threshold voltage level of the output transistor T22, the output transistor T22 of the second stage is turned on.

Then, when the drive pulse V2 at the logic “High” level is inputted to a drain of the output transistor T22, a voltage of the drive pulse V2 and a potential difference between both terminals of the bootstrap capacitor C2 are added together and applied to a gate of the output transistor T22. When a gate potential of the output transistor T22 becomes greater than the potential of the drive pulse V2, the drive pulse V2 is outputted from a node N22 as an output pulse OUT2 for use.

At the same time, the voltage of the node N22 is applied to a gate of the charge transistor T31 of a third stage, so that the charge transistor T31 is turned on. The bootstrap capacitor C3 is charged up to the power supply voltage VDD, and when the charge voltage of the bootstrap capacitor C3 exceeds the threshold voltage level of the output transistor T32, the output transistor T32 of the third stage is turned on.

By repeating the above-described operations, the signal transmission circuit further produces an output pulse OUT3 and so forth, sequentially.

In the following, the problem of the conventional signal transmission circuit described above will be described, with reference to FIG. 10.

FIG. 10 is a timing chart showing a pulse voltage of each portion of the conventional signal transmission circuit using NMOS alone. This circuit is a 5-volt circuit in which the voltage amplitudes of the drive pulses V1, V2 and the power supply voltage VDD are 5 V.

In FIG. 10, at time t0, when the start pulse VST rises to 7 V, the charge transistor T11 of the first stage is turned on, so that the bootstrap capacitor C1 is charged progressively toward 5 V, which is the power supply voltage VDD. In the case where the charge transistor T11 is an enhancement-mode NMOS, owing to a threshold voltage Vt of the transistor T11, a voltage VN11 of the node N11 to which the gate of the output transistor T12 is connected is lower than the power supply voltage VDD 5V by ΔH0, i.e., (5V−ΔH0). In this state, the output transistor T12 is turned on.

Next, at time t1, when the drive pulse V1 of 5 V is inputted to the drain of the output transistor T12, a voltage HB1 obtained by adding the drive pulse V1 of 5 V and the potential difference of (5V−ΔH0) between both the terminals of the bootstrap capacitor C1 is applied to the gate of the output transistor T12 (the node N11), so that a pulse with an amplitude H1 is outputted from the node N12.

At the same time, a pulse voltage with the amplitude H1 of the node N12 is applied to the gate of the charge transistor T21 of the second stage, so that the charge transistor T21 is turned on. Owing to a threshold voltage VT of the charge transistor T21, a voltage of the node N21 to which the gate of the output transistor T22 is connected is lower than the voltage H1 by ΔH1, i.e., (H1−ΔH1) and, thus, the bootstrap capacitor C2 is charged toward the voltage (H1−ΔH1).

Similarly, at times t2, t3 and t4, the operation of time t1 is repeated.

As described above, in the conventional signal transmission circuit, since the voltage applied to the gate of the charge transistor is only less than 5 V, the bootstrap capacitor only can be charged up to a voltage lower than 5 V, which is the power supply voltage VDD. Consequently, the voltages of the nodes N21, N31, N41 drop gradually, and then the signal transmission circuit will become unable to generate an output pulse at later stages.

Further, in the conventional signal transmission circuit described above, although it is possible to set the drive pulses V1, V2 and the power supply voltage VDD to be 5 V, the start pulse VST alone is driven at 7 V. This necessitates two kinds of power supply circuits, i.e., those of 5 V and 7 V, leading to a problem of increasing circuit size.

### SUMMARY OF THE INVENTION

It is an object of the present invention to solve the problems described above and to provide a signal transmission circuit that can be operated stably even when a power supply of the circuit has a reduced voltage and that is suitable for increasing speed or decreasing a power consumption, a solid-state imaging device to which such a signal transmission circuit is applied, a camera on which such a solid-state imaging device is mounted, and a liquid crystal display to which the above-mentioned signal transmission circuit is applied.

It is a further object of the present invention to provide a signal transmission circuit that can be operated stably even when a power supply of the circuit has a reduced voltage and share a power supply circuit between a drive pulse and a start pulse so as to reduce the circuit size, a solid-state imaging device to which such a signal transmission circuit is applied, a camera on which such a solid-state imaging device is mounted, and a liquid crystal display to which the above-mentioned signal transmission circuit is applied.

In order to achieve the above-mentioned objects, a first signal transmission circuit according to the present invention includes a plurality of stages of unit circuits from which a pulse voltage is outputted sequentially according to a drive pulse. The unit circuit of each of the plurality of stages includes an output transistor whose drain receives the drive pulse and whose source outputs it as the pulse voltage, a bootstrap capacitor connected between a gate and the source of the output transistor, and a charge transistor for charging the bootstrap capacitor. The charge transistor has a drain connected to a power supply or a ground line, a source connected to the gate of the output transistor and a gate connected to the gate of the output transistor of a preceding stage.

In the above, the gate of the charge transistor is supplied with a start pulse in the case of the unit circuit of a first stage, and the gate of the charge transistor is connected to the gate of the output transistor in the unit circuit of a preceding stage in the case of the unit circuit of a second or later stage.

With the above structure, the gate of the charge transistor in the unit circuit of the subsequent stage is supplied with a voltage higher than that in the conventional case, and thus, the gate potential of the charge transistor can be made higher than the power supply voltage VDD. Consequently, the bootstrap capacitor in the unit circuit of the subsequent stage can be charged up to the power supply voltage VDD, thereby preventing a drop in a voltage charged to the bootstrap capacitor. Accordingly, it is possible to prevent an increase in the number of transmission stages from causing a gradual decrease in output pulse voltages or the loss of an output pulse at later stages.

It is preferable that the first signal transmission circuit further includes a first discharge transistor whose drain is connected to one terminal of the bootstrap capacitor, and a second discharge transistor whose drain is connected to the other terminal of the bootstrap capacitor and that a common pulse voltage is applied to gates of the first and second discharge transistors. In this case, it is preferable that the common pulse voltage is supplied from the source of the output transistor in the unit circuit of a subsequent stage.

With this structure, simply by adding two discharge transistors, it is possible to discharge the bootstrap capacitor, so that the present invention can be applied even to a small-scale circuit structure with no other external input pulses.

It also is preferable that the first signal transmission circuit further includes a malfunction prevention transistor whose drain is connected to the gate of the output transistor in the unit circuit of a third or later stage.

With this structure, it is possible to prevent malfunction even when the output transistor has a low threshold voltage. Consequently, the range of the threshold voltage can be expanded.

Furthermore, it is preferable that the first signal transmission circuit further includes a malfunction prevention transistor, provided in the unit circuit of each of third and later stages, whose drain is connected to the gate of the output transistor and whose gate is connected to the source of the output transistor in the unit circuit of a stage before the preceding stage.

With this structure, the structure in which the gate of the malfunction prevention transistor is connected with the source of the output transistor of the unit circuit of the stage before the preceding stage makes it possible to apply the present invention even to a small-scale circuit structure with no other external input pulses.

Also, in the first signal transmission circuit, it is preferable that, during a period in which the pulse voltage is outputted from the source of the output transistor of one stage, a power supply voltage pulse that enables an operation of the charge transistor in the unit circuit of a subsequent stage and disables an operation of the charge transistor in the unit circuit of a stage after the subsequent stage is supplied to the drain of the charge transistor in the unit circuit of each of the subsequent stage and the stage after the subsequent stage. For example, in the case where the charge transistor is formed of a NMOS, a “High” level voltage is supplied to the drain of the charge transistor of the subsequent stage, and a “Low” level voltage is supplied to the drain of the charge transistor of a stage after the subsequent stage, as power supply voltage pulses. Also, in the case where the charge transistor is formed of a PMOS, a “Low” level voltage is supplied to the drain of the charge transistor of the subsequent stage, and a “High” level voltage is supplied to the drain of the charge transistor of a stage after the subsequent stage, as power supply voltage pulses.

With this structure, the malfunction prevention transistor can be omitted, thus reducing the circuit size.

In the first signal transmission circuit, in the case where all the transistors are NMOS transistors, a source of the malfunction prevention transistor is supplied with a ground potential.

In the first signal transmission circuit, in the case where all the transistors are PMOS transistors, a source of the malfunction prevention transistor is supplied with a power supply voltage.

In order to achieve the above-mentioned objects, a second signal transmission circuit according to the present invention includes a plurality of stages of unit circuits from which a pulse voltage is outputted sequentially according to a drive pulse. The unit circuit of each of the plurality of stages includes an output transistor whose drain receives the drive pulse and whose source outputs it as the pulse voltage, a bootstrap capacitor connected between a gate and the source of the output transistor, a charge transistor for charging the bootstrap capacitor, the charge transistor having a source connected to the gate of the output transistor and a drain connected to a power supply line, a ground line or a charge pulse line, and a malfunction prevention transistor whose drain is connected to the gate of the output transistor and whose gate is connected to the source or an output driven by a source output of the output transistor in another unit circuit.

With this structure, the voltage between the bootstrap capacitor and the charge transistor in the unit circuit is brought close to 0 V, thereby preventing the pulse voltage from being supplied from the output transistor in that unit circuit. Consequently, malfunction can be prevented even when the output transistor has a low threshold voltage, thus expanding the range of the threshold voltage.

In order to achieve the above-mentioned objects, a third signal transmission circuit according to the present invention includes a plurality of stages of unit circuits from which a pulse voltage is outputted sequentially according to a drive pulse. The unit circuit of each of the plurality of stages includes a first output transistor whose drain receives the drive pulse and whose source outputs it as the pulse voltage, a first bootstrap capacitor connected between a gate and the source of the first output transistor, a charge transistor for charging the first bootstrap capacitor, the charge transistor having a source connected to the gate of the first output transistor and a drain connected to a power supply line, a ground line or a charge pulse line, and a second bootstrap capacitor whose one terminal is connected to a gate of the charge transistor.

In order to achieve the above-mentioned objects, a fourth signal transmission circuit according to the present invention includes a plurality of stages of unit circuits from which a pulse voltage is outputted sequentially according to a drive pulse. The unit circuit of each of the plurality of stages includes a first output transistor whose drain receives the drive pulse and whose source outputs it as the pulse voltage, a first bootstrap capacitor connected between a gate and the source of the first output transistor, a first charge transistor for charging the first bootstrap capacitor, a second bootstrap capacitor whose one terminal is connected to a gate of the first charge transistor and whose other terminal is connected to a source or an output driven by a source output of a second output transistor, and a second charge transistor for charging the second bootstrap capacitor. The first charge transistor has a source connected to the gate of the first output transistor and a drain connected to a power supply line, a ground line or a first charge pulse line, and the second charge transistor has a source connected to one terminal of the second bootstrap capacitor, a drain connected to a power supply line, a ground line or a second charge pulse line and a gate connected to a source or an output driven by a source output of a third output transistor.

With this structure, the source output of the third output transistor (in the unit circuit of a stage before the preceding stage, for example) first is applied to the gate of the second charge transistor, and thus the second bootstrap capacitor is charged. One terminal of the second bootstrap capacitor is connected to the gate of the first charge transistor, while the other terminal is supplied with the output of the second output transistor (in the unit circuit of the preceding stage, for example), whereby the gate of the first charge transistor is supplied with a voltage higher than that in the conventional case, and thus, the gate potential of the first charge transistor can be made higher than the power supply voltage VDD. Consequently, the first bootstrap capacitor can be charged up to the power supply voltage VDD, thereby preventing a drop in a voltage charged to the first bootstrap capacitor. Accordingly, it is possible to prevent an increase in the number of transmission stages from causing a gradual decrease in output pulse voltages or a loss of an output pulse at later stages.

It is preferable that the fourth signal transmission circuit further includes a first discharge transistor whose drain is connected to the source of the first charge transistor, and a second discharge transistor whose drain is connected to the source of the second charge transistor.

Also, it is preferable that the fourth signal transmission circuit further includes a third discharge transistor connected to a terminal of the first bootstrap capacitor different from the terminal connected with the first discharge transistor, and a fourth discharge transistor connected to a terminal of the second bootstrap capacitor different from the terminal connected with the second discharge transistor.

In this case, it is preferable that the third discharge transistor and the fourth discharge transistor are the same transistor.

Furthermore, it is preferable that the drive pulse is inputted to gates of the third and fourth discharge transistors. Thus, since the drive pulse is applied directly, a stable discharge can be achieved.

Moreover, it is preferable that gates of the second discharge transistor and the third discharge transistor in the unit circuit of a preceding stage are supplied with a source voltage or an output driven by the source voltage of the first output transistor. This makes it possible to discharge the second bootstrap capacitor and the first bootstrap capacitor in the unit circuit of the preceding stage at the same time.

In this manner, simply by adding four discharge transistors, it is possible to discharge the bootstrap capacitor, so that the present invention can be applied even to a small-scale circuit structure with no other external input pulses.

In the fourth signal transmission circuit, it is preferable that the second output transistor is an output transistor in the unit circuit of a preceding stage, and the third output transistor is an output transistor in the unit circuit of a stage before the preceding stage.

With this structure, by utilizing the output of a shift register, it is possible to omit an unnecessary pulse to be applied to the gate of the charge transistor so as to reduce the circuit size.

It is preferable that the third and fourth signal transmission circuits further include a malfunction prevention transistor whose drain is connected to the gate of the first output transistor.

With this structure, it is possible to prevent malfunction even when the output transistor has a low threshold voltage. Consequently, the range of the threshold voltage can be expanded.

Also, it is preferable that the third and fourth signal transmission circuits further include a malfunction prevention transistor whose drain is connected to the gate of the first output transistor and whose gate is connected to a source of an output transistor in the unit circuit of a stage before a preceding stage.

With this structure, the structure in which the gate of the malfunction prevention transistor is connected with the source of the output transistor of the unit circuit of the stage before the preceding stage makes it possible to apply the present invention even to a small-scale circuit structure with no other external input pulses.

In the third and fourth signal transmission circuits, it is preferable that, during a period in which the pulse voltage is outputted from the source of the output transistor in the unit circuit of one stage, a power supply voltage pulse that enables an operation of the charge transistor in the unit circuit of a subsequent stage and disables an operation of the charge transistor in the unit circuit of a stage after the subsequent stage is supplied to the drain of the charge transistor in the unit circuit of each of the subsequent stage and the stage after the subsequent stage. For example, in the case where the charge transistor is formed of a NMOS, a “High” level voltage is supplied to the drain of the charge transistor of the subsequent stage, and a “Low” level voltage is supplied to the drain of the charge transistor of a stage after the subsequent stage, as power supply voltage pulses. Also, in the case where the charge transistor is formed of a PMOS, a “Low” level voltage is supplied to the drain of the charge transistor of the subsequent stage, and a “High” level voltage is supplied to the drain of the charge transistor of a stage after the subsequent stage, as power supply voltage pulses.

With this structure, the malfunction prevention transistor can be omitted, thus reducing the circuit size.

In the third and fourth signal transmission circuits, in the case where all the transistors are NMOS transistors, a source of the malfunction prevention transistor is supplied with a ground potential.

In the third and fourth signal transmission circuits, in the case where all the transistors are PMOS transistors, a source of the malfunction prevention transistor is supplied with a power supply voltage.

In order to achieve the above-mentioned objects, a fifth signal transmission circuit according to the present invention includes a plurality of stages of unit circuits from which a pulse voltage is outputted sequentially according to a drive pulse. The unit circuit of each of the plurality of stages includes an output transistor whose drain receives the drive pulse and whose source outputs it as the pulse voltage, a bootstrap capacitor connected between a gate and the source of the output transistor, a charge transistor for charging the bootstrap capacitor in the case of the unit circuit of a second or later stage, and a charge transistor for charging the bootstrap capacitor in the case of the unit circuit of a first stage. The charge transistor has a drain connected to a power supply or a ground line, a source connected to the gate of the output transistor and a gate connected to the gate of the output transistor in the unit circuit of a preceding stage, and the charge transistor has a drain connected to a power supply or a ground line or supplied with a start pulse, a source connected to the gate of the output transistor and a gate supplied with the start pulse via one capacitor or a series capacitor including a plurality of capacitors.

In the fifth signal transmission circuit, it is preferable that the unit circuit of the first stage includes a first initial charge transistor whose source or drain is connected to one terminal of the one capacitor or the series capacitor on a side of the charge transistor and whose drain or source is connected to the power supply or the ground line, respectively, and a second initial charge transistor whose source or drain is connected to the other terminal of the one capacitor or the series capacitor and whose drain or source is connected to a ground or the power supply, respectively.

In the fifth signal transmission circuit, it is preferable that the unit circuit of the first stage includes a first initial charge transistor whose source or drain is connected to one terminal of a capacitor in the series capacitor on a side of the charge transistor and whose drain or source is connected to the power supply or the ground line, respectively, and a second initial charge transistor whose source or drain is connected to the other terminal of the capacitor in the series capacitor and whose drain or source is connected to a ground or the power supply, respectively.

In this case, it is preferable that, after turning on and off the first and second initial charge transistors corresponding to the capacitor closer to the charge transistor, the input pulse turns on and off the first and second initial charge transistors corresponding to the next capacitor.

With the above structure, after the capacitor or the series capacitor whose one terminal is connected to the gate of the charge transistor in the unit circuit of the first stage (an input bootstrap capacitor) is charged by the first and second initial charge transistors that are turned on when the drive pulse (for example, V2) is applied in common to their gates such that one terminal of the input bootstrap capacitor is connected to the power supply voltage VDD and the other terminal is connected to the ground voltage VSS, the first and second initial charge transistors are turned off, followed by applying the start pulse VST to the other terminal of the input bootstrap capacitor, thereby raising the gate voltage of the charge transistor of the first stage. This makes it possible to prevent a drop in a voltage charged to the bootstrap capacitor that is connected to the source of the charge transistor of the first stage. Accordingly, it is possible to prevent an increase in the number of transmission stages from causing a gradual decrease in output pulse voltages or a loss of an output pulse at later stages. Furthermore, a common (3-volt system) power supply circuit can be used for the drive pulse and the start pulse, thus allowing a smaller-scale circuit.

In order to achieve the above-mentioned objects, a first solid-state imaging device according to the present invention includes the first, third or fourth signal transmission circuit.

In order to achieve the above-mentioned objects, a first camera according to the present invention includes the first solid-state imaging device.

In order to achieve the above-mentioned objects, a first liquid crystal display according to the present invention includes the first, third or fourth signal transmission circuit.

With the above-described structure, it is possible to secure stable operation even when the power supply of the circuit has a reduced voltage. In particular, this structure is effective in a solid-state imaging device, a camera including the same, and a liquid crystal display that are to be applied to portable equipment requiring a reduction of power consumption.

In order to achieve the above-mentioned objects, a second solid-state imaging device according to the present invention includes the fifth signal transmission circuit.

In order to achieve the above-mentioned objects, a second camera according to the present invention includes the second solid-state imaging device.

In order to achieve the above-mentioned objects, a second liquid crystal display according to the present invention includes the fifth signal transmission circuit.

With the above-described structure, it is possible to secure a stable operation even when the power supply of the circuit has a reduced voltage and to reduce the circuit size. In particular, this structure is effective in a solid-state imaging device, a camera including the same, and a liquid crystal display that are to be applied to portable equipment requiring reductions of power consumption and size.

### BRIEF DESCRIPTION OF THE DRAWINGS

FIG. 1 is a circuit diagram showing an example of a signal transmission circuit according to a first embodiment of the present invention.

FIG. 2 is a circuit diagram showing another example of a signal transmission circuit according to the first embodiment of the present invention.

FIG. 3 is a timing chart showing a pulse voltage of each portion of the signal transmission circuit shown in FIG. 1.

FIG. 4 is a circuit diagram showing an example of a signal transmission circuit according to a second embodiment of the present invention.

FIG. 5 is a circuit diagram showing an example of a signal transmission circuit according to a third embodiment of the present invention.

FIG. 6 is a timing chart showing a pulse voltage of each portion of the signal transmission circuit shown in FIG. 5.

FIG. 7 is a circuit diagram showing an example of a signal transmission circuit according to a fourth embodiment of the present invention.

FIG. 8 is a timing chart showing a pulse voltage of each portion of the signal transmission circuit shown in FIG. 7.

FIG. 9 is a circuit diagram showing an example of a conventional signal transmission circuit.

FIG. 10 is a timing chart showing a pulse voltage of each portion of the signal transmission circuit shown in FIG. 9.

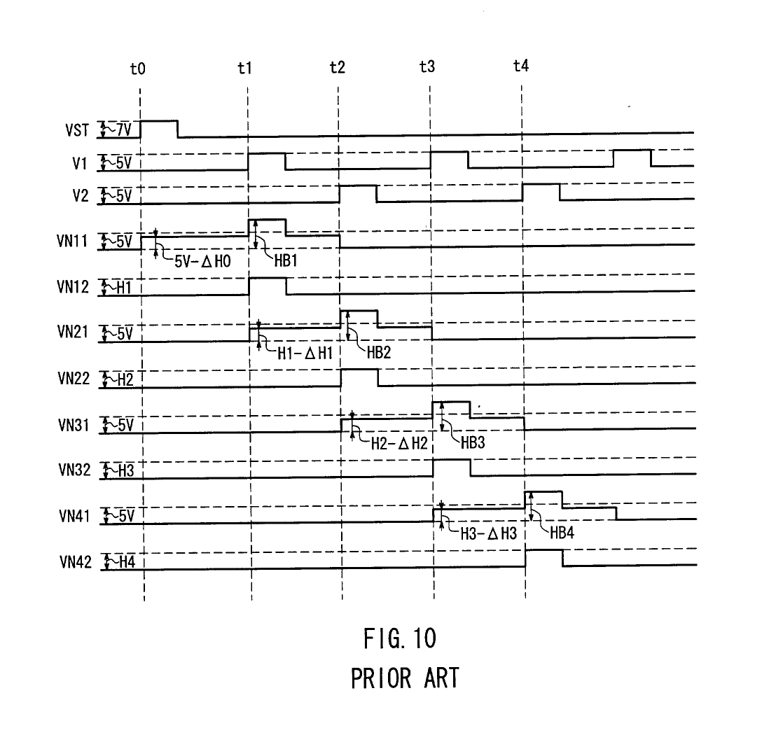

FIG. 11 is a block diagram showing an example of a MOS-type solid-state imaging device as a solid-state imaging device according to a fifth embodiment of the present invention.

FIG. 12 is a block diagram showing an example of a camera according to a sixth embodiment of the present invention.

FIG. 13 is a block diagram showing an example of a liquid crystal display according to a seventh embodiment of the present invention.

### DESCRIPTION OF THE PREFERRED EMBODIMENTS

The following is a description of preferred embodiments of the present invention, with reference to the accompanying drawings.

First Embodiment

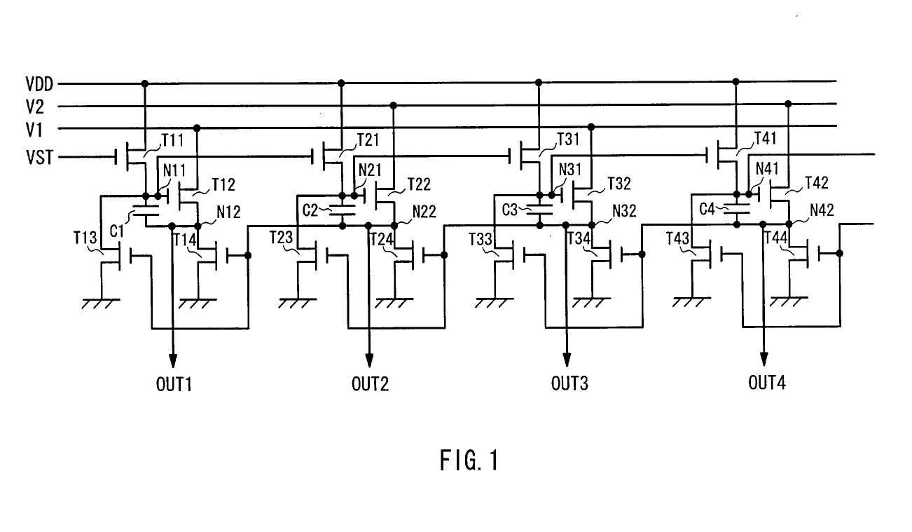

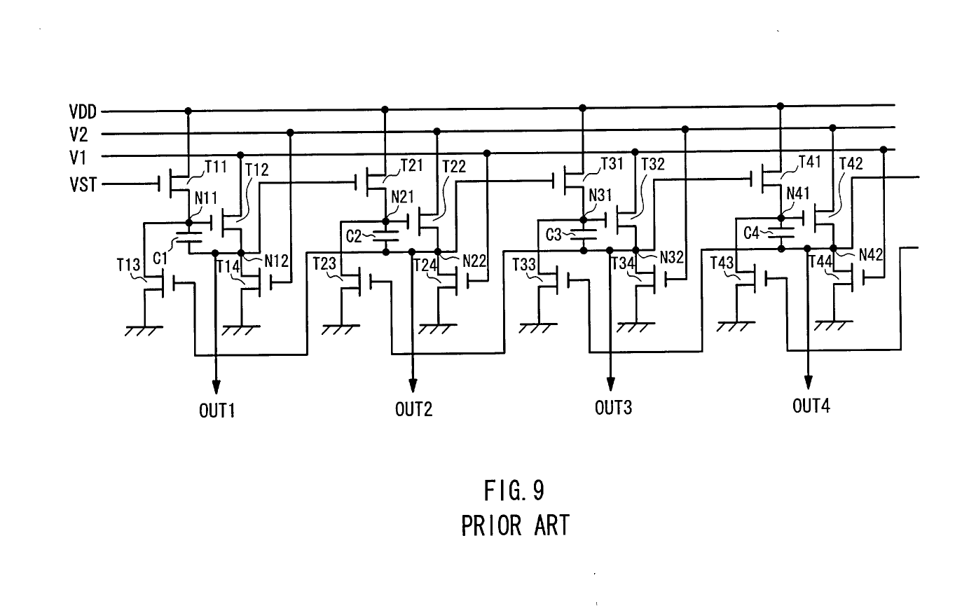

FIG. 1 is a circuit diagram showing an example of a signal transmission circuit according to the first embodiment of the present invention. The present embodiment is different from the conventional example shown in FIG. 9 in that a gate of an output transistor in a unit circuit of one stage is connected to a gate of a charge transistor in a unit circuit of the next stage. Other structures are the same as those in the conventional example shown in FIG. 9 and given the same numerals in FIG. 1.

In FIG. 1, when the start pulse VST reaches a logic “High” level, the charge transistor T11 in a unit circuit of the first stage is turned on, and the bootstrap capacitor C1 is charged up to the power supply voltage VDD. When the charge voltage of the bootstrap capacitor C1 exceeds a threshold voltage level of the output transistor T12, the output transistor T12 in the unit circuit of the first stage is turned on.

Thereafter, when the drive pulse V1 at the logic “High” level is inputted to a drain of the output transistor T12, the voltage of the drive pulse V1 and a potential difference between both terminals of the bootstrap capacitor C1 are added together and applied to a gate of the output transistor T12. When a gate potential of the output transistor T12 becomes greater than the potential of the drive pulse V1, the drive pulse V1 is outputted from an output node N12 in the unit circuit of the first stage as an output pulse OUT1 for use.

Herein, the signal transmission circuit according to the present embodiment is advantageous in that, since the voltage of the node N11 connected to a positive-side terminal of the bootstrap capacitor C1 is applied to the gate of the charge transistor T21 in a unit circuit of the second stage, a high voltage can be applied to the gate of the charge transistor T21. Thus, even if the charge transistor T21 in the unit circuit of the second stage is an enhancement-mode NMOS, it is possible to charge reliably the bootstrap capacitor C2 up to the power supply voltage VDD and turn on the output transistor T22.

Then, when the drive pulse V2 at the logic “High” level is inputted to a drain of the output transistor T22, a voltage of the drive pulse V2 and a potential difference between both terminals of the bootstrap capacitor C2 are added together and applied to a gate of the output transistor T22. When a gate potential of the output transistor T22 becomes greater than the potential of the drive pulse V2, the drive pulse V2 is outputted from an output node N22 in the unit circuit of the second stage as an output pulse OUT2 for use.

At the same time, a high voltage of the node N21, which is connected to a positive-side terminal of the bootstrap capacitor C2, is applied to a gate of the charge transistor T31 in a unit circuit of the third stage, so that the charge transistor T31 is turned on. The bootstrap capacitor C3 is charged reliably up to the power supply voltage VDD, and the output transistor T32 is turned on.

By repeating the above-described operations, the signal transmission circuit further outputs output pulses OUT3, OUT4 and so forth, sequentially.

In this manner, at every signal transmission stage, a positive-side terminal voltage of the bootstrap capacitor is applied to the gate of the charge transistor in the unit circuit of its subsequent stage. Therefore, the bootstrap capacitor in the unit circuit of the subsequent stage can be charged reliably up to the power supply voltage VDD, thus achieving a signal transmission circuit that causes no drop in voltage and can generate an output pulse at a low voltage.

Also, for discharging the voltage charged in the bootstrap capacitor, in order to reduce the number of transistors and power supplies in a circuit, the drain of the discharge transistor T13 is connected to the positive-side terminal of the bootstrap capacitor C1, the drain of the discharge transistor T14 is connected to the negative-side terminal of the bootstrap capacitor C1, and the gates of the discharge transistors T13 and T14 are connected with the output node N22 connected to the source of the output transistor T22 in the unit circuit of the second stage, in the case of the bootstrap capacitor C1. In this way, when the drive pulse V2 is outputted to the output node N22 in the unit circuit of the second stage, the bootstrap capacitor C1 can be discharged.

With this structure, simply by adding two discharge transistors, it is possible to discharge the bootstrap capacitor, thus achieving the signal transmission circuit of the present embodiment even in a small-scale circuit structure with no other external input pulses.

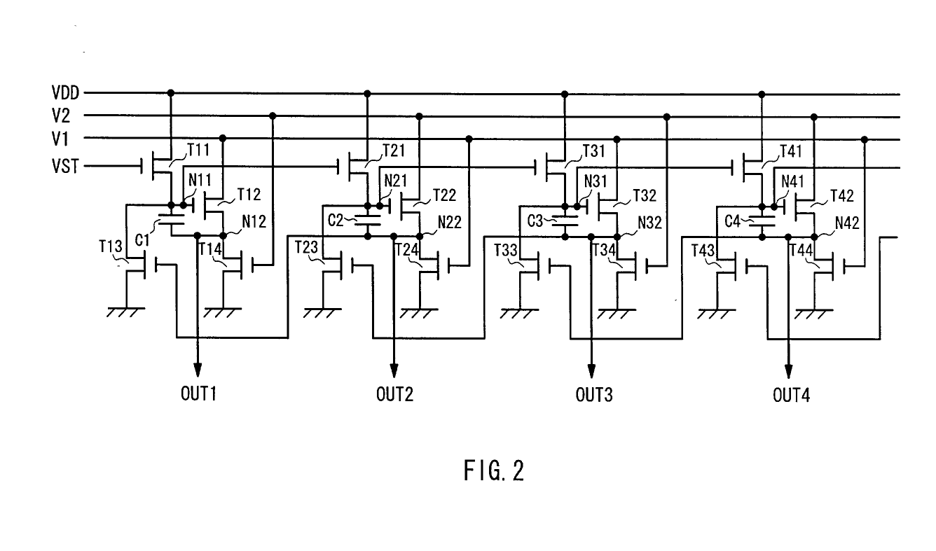

Incidentally, as shown in FIG. 2, the negative side of the bootstrap capacitor also may be discharged using the drive pulse V1 or V2 as in a conventional manner.

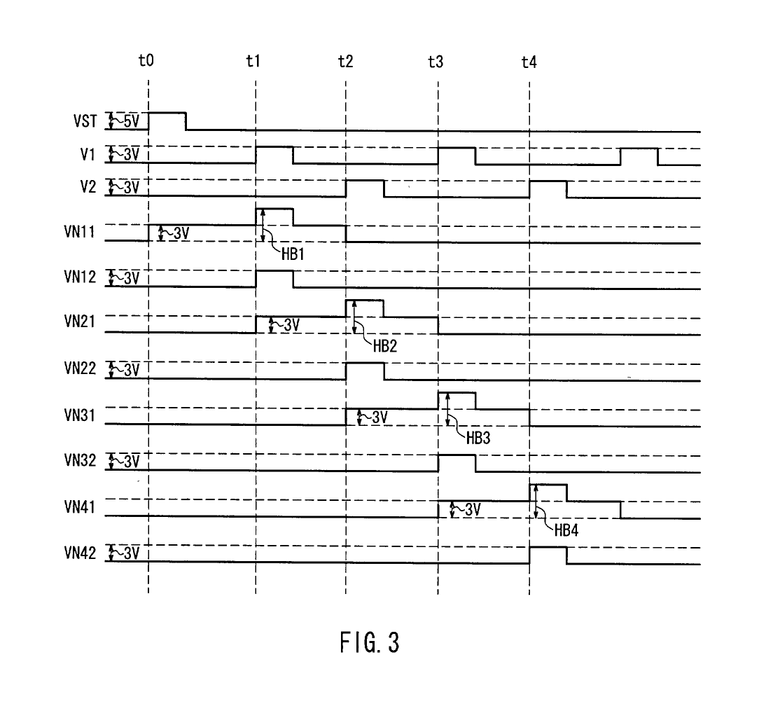

FIG. 3 is a timing chart showing a pulse voltage of each portion of the signal transmission circuit shown in FIG. 1 using NMOS alone. This circuit is a 3-volt circuit, and the voltage amplitudes of the drive pulses V1, V2 and the power supply voltage VDD are 3 V. However, the voltage amplitude of the start pulse VST is set to be 5 V. The following is the reason why only the voltage amplitude of the start pulse VST is set to be 5 V. Since the charge transistor T11 of the first stage, to which the start pulse VST is inputted, alone cannot be supplied with a high voltage from the preceding stage, the charge transistor T11 is driven by the start pulse VST at 5 V, which is higher than the voltage amplitude 3 V of the drive pulses V1 and V2, thereby preventing a voltage drop by the charge transistor T11 and making it possible to charge the bootstrap capacitor C1 up to the power supply voltage VDD, i.e., 3 V.

In FIG. 3, at time t0, the voltage of the start pulse VST rises to 5 V, so that the bootstrap capacitor C1 is charged up to the power supply voltage VDD, i.e., 3 V via the charge transistor T11 even when the charge transistor T11, which is an enhancement-mode NMOS, has a threshold voltage Vt, and then the output transistor T12 is turned on.

Next, at time t1, when the drive pulse V1 rises to 3 V and is inputted to the drain of the output transistor T12, the high voltage HB1 obtained by adding the voltage 3 V of the drive pulse V1 and the potential difference 3 V between both the terminals of the bootstrap capacitor C1 is applied to the gate of the output transistor T12. Therefore, the drive pulse V1 with an amplitude of 3 V reliably is outputted from the output node N12 as the output pulse OUT1.

At the same time, the high voltage HB1 of the node N11 connected to a positive-side terminal of the bootstrap capacitor C1 is inputted to the gate of the charge transistor T21 in the unit circuit of the second stage, so that the charge transistor T21 is turned on. Accordingly, the bootstrap capacitor C2 reliably is charged up to 3 V, which is the power supply voltage VDD.

Similarly, at times t2, t3 and t4, the operation of time t1 is repeated.

As described above, according to the present embodiment, the positive-side terminal voltage of the bootstrap capacitor in the unit circuit of one stage always is applied to the gate of the charge transistor in the unit circuit of its subsequent stage. Therefore, the bootstrap capacitor in the unit circuit of the subsequent stage can be charged reliably up to the power supply voltage 3 V, thus achieving a signal transmission circuit that causes no drop in voltage and can generate an output pulse at a low voltage of 3 V.

Second Embodiment

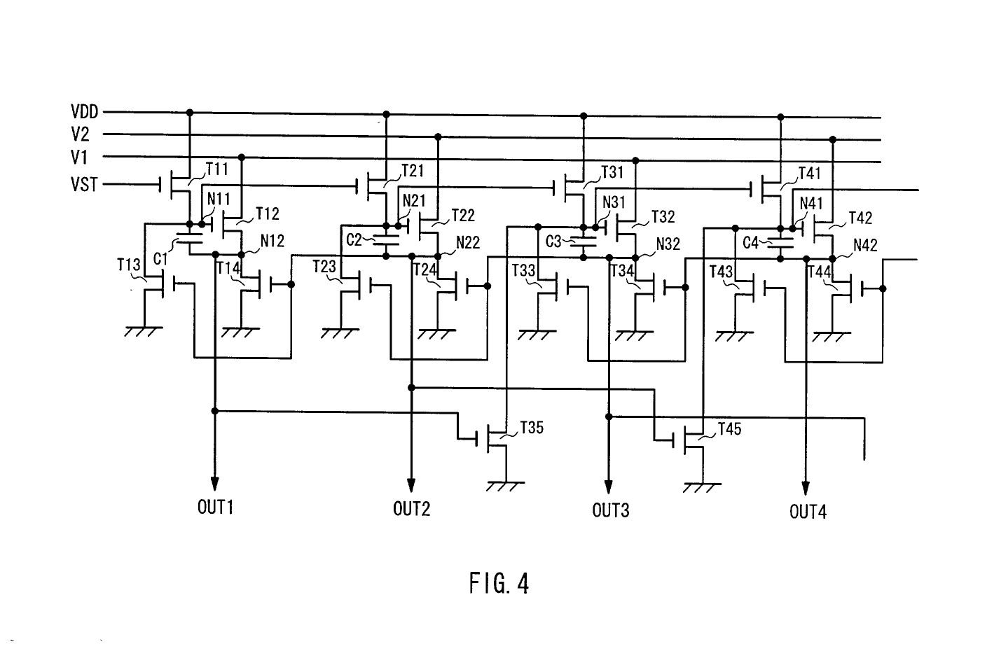

FIG. 4 is a circuit diagram showing an example of a signal transmission circuit according to the second embodiment of the present invention. The present embodiment is different from the first embodiment in that malfunction prevention transistors (T35, T45) are added to the positive-side terminals of the bootstrap capacitors. In the following, the description focuses only on this difference.

When the bootstrap capacitor C2 in the unit circuit of the second stage is charged up to 3 V, there is a possibility that the charge transistor T31, whose gate is connected with the node N21 (3V) connected to the positive-side terminal of the bootstrap capacitor C2, is turned on and the bootstrap capacitor C3 of the third stage is charged to have a voltage as low as 3 V or less, in the case where the charge transistor T31, which is an enhancement-mode NMOS, has a low threshold voltage. In this state, there is a possibility that, in the case where the drive pulse V1 is 3 V at a logic “High” level, the drive pulse V1 is outputted also to the output node N32 in the unit circuit of the third stage at the same time when it is outputted to the output node N12 in the unit circuit of the first stage.

Accordingly, as shown in FIG. 4, the positive terminal side of the bootstrap capacitor C3 is brought closer to a ground potential, and a malfunction prevention transistor T35 is connected between the positive terminal side of the bootstrap capacitor C3 and the ground potential so that the output transistor T32 in the unit circuit of the third stage is turned off. In other words, a drain of the malfunction prevention transistor T35 is connected to the positive side of the bootstrap capacitor C3, a source thereof is connected to the ground potential, a gate thereof is connected to the output node N12 in the unit circuit of the first stage. Then, when the drive pulse V1 is outputted to the output node N12 of the first stage, the malfunction prevention transistor is turned on so as to bring the node N31 close to 0 V, thereby preventing the drive pulse V1 from being supplied to the output node N32 in the unit circuit of the third stage.

At this time, the conductance of the charge transistor T31 is made smaller than that of the malfunction prevention transistor T35, whereby it becomes possible to bring the positive terminal side of the bootstrap capacitor C3 closer to 0 V, preventing malfunction more reliably.

Similarly, in a unit circuit of the subsequent stage, a drain and a source of a malfunction prevention transistor T45 are connected between a positive terminal side of a bootstrap capacitor C4 and a ground potential, and a gate thereof is connected to the output node N22 in the unit circuit of the stage before its preceding stage, thereby preventing malfunction at every stage.

As described above, according to the present embodiment, by providing the malfunction prevention transistor, it is possible to prevent malfunction even when the output transistor has a low threshold voltage. Consequently, the range of the threshold voltage can be expanded.

Furthermore, the structure in which the gate of the malfunction prevention transistor is connected with the source of the output transistor of the unit circuit of the stage before the preceding stage makes it possible to achieve the signal transmission circuit according to the present embodiment even in the case of a small-scale circuit structure with no other external input pulses.

Third Embodiment

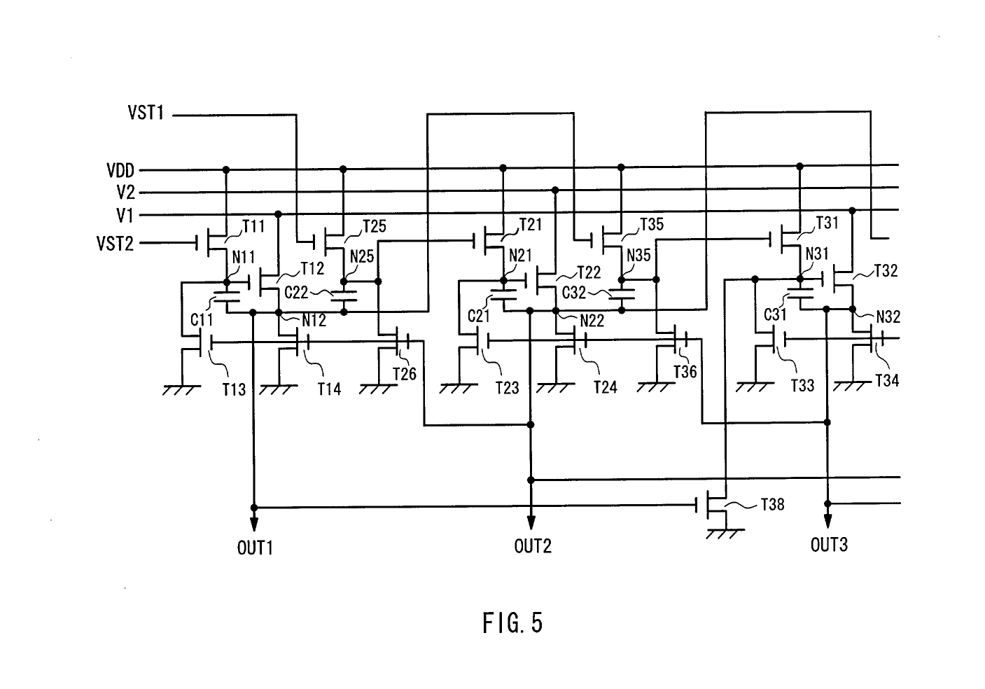

FIG. 5 is a circuit diagram showing an example of a signal transmission circuit according to the third embodiment of the present invention. The present embodiment is different from the second embodiment in that second bootstrap capacitors (C22, C32), second charge transistors (T25, T35), third discharge transistors (T26, T36) in the unit circuit of the second stage or later, and a malfunction prevention transistor (T38) in the unit circuit of the third stage or later are added and that the positive-side terminals (nodes N25, N35) of the second bootstrap capacitors are connected to the gates of the first charge transistors (T21, T31) in the unit circuit of their own stage, and the negative-side terminals (nodes N12, N22) of the second bootstrap capacitors are connected to the gates of the second charge transistors (T25, T35) in the unit circuit of their subsequent stage. The second charge transistors (T25, T35) charge the second bootstrap capacitors, and the third discharge transistors (T26, T36) discharge the electric charge between both terminals of the second bootstrap capacitors. The malfunction prevention transistor (T38) has a drain connected with a positive-side terminal (a node N31) of the first bootstrap capacitor (C31), a gate connected with an output node (N12) in the unit circuit of the stage before the preceding stage and a source that is grounded.

In FIG. 5, when the start pulse VST2 reaches a logic “High” level, the first charge transistor T11 for charging the first bootstrap capacitor C11 in a unit circuit of the first stage is turned on, and the first bootstrap capacitor C11 is charged by the power supply voltage VDD. When the charge voltage of the first bootstrap capacitor C11 exceeds a threshold voltage level of the output transistor T12, the output transistor T12 in the unit circuit of the first stage is turned on.

Also, when the start pulse VST1 reaches a logic “High” level, the second charge transistor T25 for charging the second bootstrap capacitor C22 in a unit circuit of the second stage is turned on, and the second bootstrap capacitor C22 is charged by the power supply voltage VDD.

Thereafter, when the drive pulse V1 at the logic “High” level is inputted to a drain of the output transistor T12, the voltage of the drive pulse V1 and a potential difference between both terminals of the first bootstrap capacitor C11 are added together and applied to a gate of the output transistor T12. When a gate potential of the output transistor T12 becomes greater than the potential of the drive pulse V1, the drive pulse V1 is outputted from an output node N12 in the unit circuit of the first stage as an output pulse OUT1 for use.

Here, the signal transmission circuit according to the present embodiment is advantageous in that the voltage of the drive pulse V1 outputted to the output node N12 and a potential difference between both terminals of the second bootstrap capacitor C22 are added together and applied to a gate of the first charge transistor T21 in the unit circuit of the second stage connected to the node N25 of the positive-side terminal of the charged second bootstrap capacitor C22, so that the gate potential of the first charge transistor T21 becomes greater than the power supply voltage VDD serving as a drain potential, making it possible to charge the first bootstrap capacitor C21 in the unit circuit of the second stage up to the power supply voltage VDD.

Thus, even if the first charge transistor T21 for charging the first bootstrap capacitor C21 in the unit circuit of the second stage is an enhancement-mode NMOS, it is possible to charge reliably the first bootstrap capacitor C21 up to the power supply voltage VDD and turn on the output transistor T22.

Also, a second charge transistor T35, whose gate is connected to the output node N12, in the unit circuit of the third stage is turned on at the same time the drive pulse V1 is outputted to the output node N12, so that a second bootstrap capacitor C32 in the unit circuit of the third stage is charged.

Then, when the drive pulse V2 at the logic “High” level is inputted to a drain of the output transistor T22, a voltage of the drive pulse V2 and a potential difference between both terminals of the first bootstrap capacitor C21 are added together and applied to a gate of the output transistor T22. When a gate potential of the output transistor T22 becomes greater than the potential of the drive pulse V2, the drive pulse V2 is outputted from an output node N22 in the unit circuit of the second stage as an output pulse OUT2 for use.

At the same time, a voltage of the drive pulse V2 outputted to the output node N22 and a potential difference between both terminals of the second bootstrap capacitor C32 are added together and applied to a gate of the first charge transistor T31 in the unit circuit of the third stage connected to the node N35 serving as the positive-side terminal of the second bootstrap capacitor C32, so that a gate potential of the first charge transistor T31 becomes greater than the power supply voltage VDD serving as a drain potential. Thus, the first bootstrap capacitor C31 in the unit circuit of the third stage is charged reliably up to the power supply voltage VDD, and the output transistor T32 is turned on.

By repeating the above-described operations, the signal transmission circuit further outputs output pulses OUT3 and so forth, sequentially.

In this manner, at every signal transmission stage, the first bootstrap capacitor can be charged reliably up to the power supply voltage VDD, thus achieving a signal transmission circuit that causes no drop in voltage and can generate an output pulse at a low voltage.

Also, for discharging the voltage charged in the bootstrap capacitor, in order to reduce the number of transistors and power supplies in a circuit, the drain of the first discharge transistor T23 is connected to the positive-side terminal of the first bootstrap capacitor C21, the drain of the second discharge transistor T24 is connected to the negative-side terminal of the first bootstrap capacitor C21, and the gates of the first discharge transistor T23 and the second discharge transistor T24 are connected with the output node N32 connected to the source of the output transistor T32 in the unit circuit of the third stage as the subsequent stage, in the case of the first bootstrap capacitor C21 in the unit circuit of the second stage. In this way, when the drive pulse V1 is outputted to the output node N32 in the unit circuit of the third stage, the first bootstrap capacitor C21 in the unit circuit of the second stage can be discharged.

On the other hand, the drain of the third discharge transistor T26 is connected to the positive-side terminal of the second bootstrap capacitor C22, and the gate of the third discharge transistor T26 is connected with the output node N22 connected to the source of the output transistor T22 in the unit circuit of the second stage as the present stage, in the case of the second bootstrap capacitor C22 in the unit circuit of the second stage. In this way, when the drive pulse V2 is outputted to the output node N22 in the unit circuit of the second stage, the second bootstrap capacitor C22 in the unit circuit of the second stage can be discharged.

With this structure, simply by adding three discharge transistors, it is possible to discharge the first and second bootstrap capacitors, thus achieving the signal transmission circuit of the present embodiment even in a small-scale circuit structure with no other external input pulses.

Also, the malfunction prevention transistor T38 is provided, whose drain is connected to the positive-side terminal (the node N31) of the first bootstrap capacitor C31 in the unit circuit of the third stage, whose gate is connected to the output node N12 in the unit circuit of the first stage and whose source is grounded. When the second bootstrap capacitor C32 in the unit circuit of the third stage is charged, the first charge transistor T31 is turned on to a certain extent by a potential of a node 35. Then, since the first bootstrap capacitor C31 is charged to a certain extent, the output transistor T32 slightly is turned on in the case where the output transistor T32 has a low threshold voltage. In this state, there is a possibility that, when the drive pulse V1 is outputted also to the output node N32 in the unit circuit of the third stage at the same time when it is outputted to the output node N12 in the unit circuit of the first stage.

In order to prevent the drive pulse V1 from being outputted to the output node N32, the malfunction prevention transistor T38 is provided. When the drive pulse V1 is outputted to the output node N12 in the unit circuit of the first stage, the malfunction prevention transistor T38 is turned on so as to bring the node N31 close to 0 V, thereby preventing the drive pulse V1 from being supplied to the output node N32 in the unit circuit of the third stage.

At this time, the conductance of the first charge transistor T31 in the unit circuit of the third stage is made smaller than that of the malfunction prevention transistor T38, thereby bringing the positive terminal side of the first bootstrap capacitor C31 closer to 0 V, preventing malfunction more reliably.

As described above, by providing the malfunction prevention transistor in the unit circuit of each of the third stage and thereafter and applying the output pulse in the unit circuit of the stage before its preceding stage to the gate of the malfunction prevention transistor, it is possible to prevent malfunction even when the output transistor has a low threshold voltage. Consequently, the range of the threshold voltage can be expanded.

Furthermore, the structure in which the gate of the malfunction prevention transistor is connected with the source of the output transistor of the unit circuit of the stage before its preceding stage makes it possible to achieve the signal transmission circuit according to the present embodiment even in the case of a small-scale circuit structure with no other external input pulses.

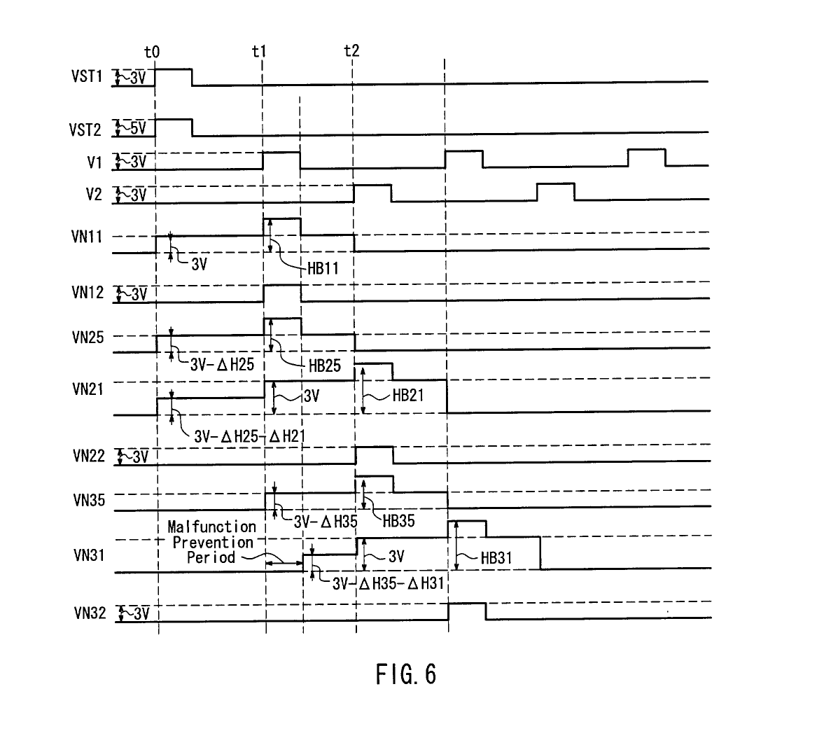

FIG. 6 is a timing chart showing a pulse voltage of each portion of the signal transmission circuit shown in FIG. 5 using NMOS alone. This circuit is a 3-volt circuit, and the voltage amplitudes of the drive pulses V1, V2 and the power supply voltage VDD are 3 V. However, the voltage amplitude of the start pulse VST2 is set to be 5 V, and that of the start pulse VST1 is set to be 3 V. The following is the reason why only the voltage amplitude of the start pulse VST2 is set to be 5 V. Since the first charge transistor T11 in the unit circuit of the first stage, to which the start pulse VST2 is inputted, alone cannot be supplied with a high voltage from the preceding stage, the first charge transistor T11 is driven by the start pulse VST2 at 5 V, which is higher than the voltage amplitude 3 V of the drive pulses V1, V2, thereby preventing a voltage drop by the first charge transistor T11 and making it possible to charge the first bootstrap capacitor C11 up to the power supply voltage VDD, i.e., 3 V.

In FIG. 6, at time t0, the voltage of the start pulse VST2 rises to 5 V, so that the first bootstrap capacitor C11 is charged up to the power supply voltage VDD, i.e., 3 V via the first charge transistor T11 even when the first charge transistor T11, which is an enhancement-mode NMOS, has a threshold voltage Vt, and then the output transistor T12 is turned on.

At the same time, the voltage of the start pulse VST1 rises to 3 V, and then the second bootstrap capacitor C22 is charged via the second charge transistor T25.

Next, at time t1, when the drive pulse V1 rises to 3 V and is inputted to the drain of the output transistor T12, the high voltage HB11, which is obtained by adding the voltage of 3 V of the drive pulse V1 and the potential difference of 3 V between both terminals of the bootstrap capacitor C11, is applied to the gate of the output transistor T12. Therefore, the drive pulse V1 with an amplitude of 3 V reliably is outputted from the output node N12 as the output pulse OUT1.

At the same time, the high voltage HB25 of the node N25 connected to a positive-side terminal of the second bootstrap capacitor C22 is inputted to the gate of the first charge transistor T21, so that the first charge transistor T21 is turned on. Accordingly, the first bootstrap capacitor C21 reliably is charged up to 3 V, which is the power supply voltage VDD.

At this time, a voltage lower than 3 V, i.e., (3 V−ΔH35) is applied to the node N35, and the same voltage is applied also to the gate of the first charge transistor T31. In this case, the malfunction prevention transistor T38 is turned on and the node N31 is brought closer to the ground potential so that the potential of the node N31 connected to the source of the first charge transistor T31 does not become equal to or greater than the threshold voltage of the first charge transistor T31, thereby preventing the drive pulse V1 from being outputted to the node N32 at time t1.

Similarly, at times t2 and t3, the operation of time t1 is repeated.

As described above, according to the present embodiment, the positive-side terminal voltage of the second bootstrap capacitor always is applied to the gate of the first charge transistor. Therefore, the first bootstrap capacitor can be charged reliably up to the power supply voltage of 3 V, thus achieving a signal transmission circuit that causes no drop in voltage and can generate an output pulse at a low voltage of 3 V.

Furthermore, in the present embodiment, the source voltage of the output transistor can be raised by increasing the amplitude using a driving circuit.

Fourth Embodiment

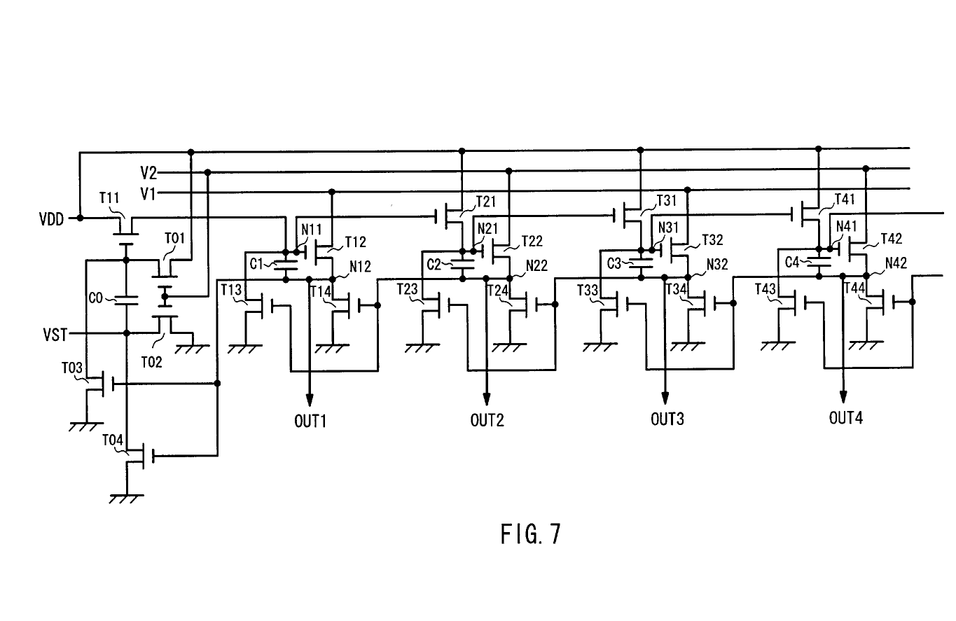

FIG. 7 is a circuit diagram showing an example of a signal transmission circuit according to the fourth embodiment of the present invention. In FIG. 7, the present embodiment is different from the first embodiment shown in FIG. 1 in that an input bootstrap capacitor C0, a first initial charge transistor T01, a second initial charge transistor T02 and discharge transistors T03, T04 are provided. The input bootstrap capacitor C0 has one terminal connected to the gate of the charge transistor T11 in a unit circuit of the first stage and the other terminal to which the start pulse VST is supplied. The first initial charge transistor T01 has a source connected to the one terminal of the input bootstrap capacitor C0, a drain to which the power supply voltage VDD is supplied and a gate to which the drive pulse V2 is applied. The second initial charge transistor T02 has a drain connected to the other terminal of the input bootstrap capacitor C0, a source to which a ground voltage (0 V) is supplied and a gate to which the drive pulse V2 is applied. The discharge transistors T03, T04 discharge an electric charge of the input bootstrap capacitor C0. Other structures are the same as those in the first embodiment shown in FIG. 1 and given the same numerals in FIG. 7. Accordingly, the description thereof will be omitted.

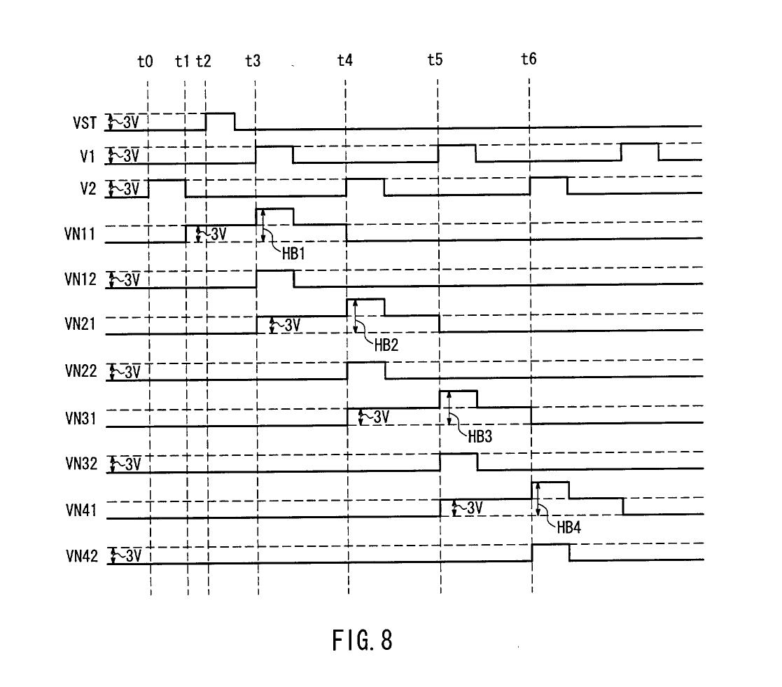

The following is a description of an operation of a signal transmission circuit constituted as above, with reference to FIG. 8.

FIG. 8 is a timing chart showing a pulse voltage of each portion of the signal transmission circuit shown in FIG. 7 using NMOS alone. This circuit is a 3-volt circuit, and the voltage amplitudes of the start pulse VST, the drive pulses V1, V2 and the power supply voltage VDD are 3 V.

In FIG. 8, first, at time t0 when the drive pulse V2 rises to 3 V, the first initial charge transistor T01 and the second initial charge transistor T02 are both turned on, so that the input bootstrap capacitor C0 is charged to 3 V.

Next, at time t1 when the drive pulse V2 falls to 0 V, the first initial charge transistor T01 and the second initial charge transistor T02 are both turned off.

Then, at time t2 when the start pulse VST rises to 3 V, the voltage of the start pulse VST and the charge voltage of the input bootstrap capacitor C0 are added together and applied to the gate of the charge transistor T11 in the unit circuit of the first stage, so that the gate voltage of the charge transistor T11 reaches the power supply voltage VDD of 3 V or more. Accordingly, the bootstrap capacitor C1 can be charged up to 3 V, which is the power supply voltage VDD, via the charge transistor T11. This allows driving even when the voltage amplitude of the start pulse VST also is 3 V like that of the drive pulses V1, V2.

Next, at time t3, when the drive pulse V1 rises to 3 V and is inputted to the drain of the output transistor T12, the high voltage HB1 obtained by adding the voltage of 3 V of the drive pulse V1 and the potential difference of 3 V between both terminals of the bootstrap capacitor C1 is applied to the gate of the output transistor T12. Therefore, the drive pulse V1 with an amplitude of 3 V reliably is outputted from the output node N12 as the output pulse OUT1.

At the same time, the high voltage HB1 of the node N11 connected to a positive-side terminal of the bootstrap capacitor C1 is inputted to the gate of the charge transistor T21 in the unit circuit of the second stage, so that the charge transistor T21 is turned on. Accordingly, the bootstrap capacitor C2 reliably is charged up to 3 V, which is the power supply voltage VDD.

Similarly, at times t4, t5 and t6, the operation of time t3 is repeated.

As described above, according to the present embodiment, the input bootstrap capacitor C0 is provided between the gate of the charge transistor T11 in the unit circuit of the first stage and a line of the start pulse VST, the input bootstrap capacitor C0 is charged via the first initial charge transistor T01 and the second initial charge transistor T02, and then the start pulse VST is applied, thereby achieving a signal transmission circuit that causes no drop in voltage and can generate an output pulse stably at a low voltage of 3 V even when the voltage amplitude of the start pulse VST is as low as 3 V, which is equal to those of the drive pulses V1, V2. Also, since a common power supply circuit of 3 V can be used for the start pulse VST and the drive pulses V1, V2, it is possible to reduce the number of the power supply circuits so as to achieve a circuit smaller than the conventional ones.

The present embodiment has illustrated the case of providing one input bootstrap capacitor C0. However, when a plurality of input bootstrap capacitors are connected in series and charged sequentially from the input bootstrap capacitor closer to the line of the start pulse VST, followed by applying the start pulse VST, it is possible to increase the gate voltage to be inputted to the charge transistor T11 in the unit circuit of the first stage.

When a plurality of input bootstrap capacitors are connected in series as described above, the power supply voltage to be supplied to the initial charge transistor closer to the gate of the charge transistor T11 in the unit circuit of the first stage is made larger than that to be supplied to the initial charge transistor farther therefrom among the power supplies for supplying the initial charge transistors connected to both terminals of each input bootstrap capacitor. In this way, the largest voltage can be applied to the gate of the charge transistor T11 in the unit circuit of the first stage.

Also, in the present embodiment, since a common pulse is supplied to the gates of the initial charge transistors T01, T02 connected to both the terminals of the input bootstrap capacitor C0, only one gate circuit for the initial charge transistor is needed, thus reducing the circuit size and increasing the charging speed.

Furthermore, in the present embodiment, the drive pulse V2 of the signal transmission circuit is used as the common pulse to be supplied to the gates of the initial charge transistors connected to both the terminals of the input bootstrap capacitor C0, thereby reducing the circuit size and matching phases of the charging and the drive pulse so as to perform high-speed driving.

Although the sources of the discharge transistor and malfunction prevention transistor have been a ground potential (0 V) in the embodiments described above, a similar effect also can be obtained even when each source voltage is not 0 V but any value smaller than the threshold voltage of the output transistor.

In the above-described embodiments, since a DC voltage as the power supply voltage VDD is applied to the drain of the charge transistor, there arises a possibility that a malfunction occurs, so it is necessary to incorporate a malfunction prevention transistor. In response to this, by applying a pulse voltage as the power supply voltage VDD to the drain of the charge transistor, it is possible to prevent the malfunction. In other words, during the period in which an output voltage is generated in the source of the output transistor, by setting the drain of the charge transistor in the unit circuit of its subsequent stage at “High” level and the drain of the charge transistor of the stage after the subsequent stage at “Low” level, it is possible to omit the malfunction prevention transistor.

Furthermore, although the above-described embodiments have illustrated the case of using NMOS transistors, the similar effect also can be achieved even in the case where they are all PMOS transistors.

Fifth Embodiment

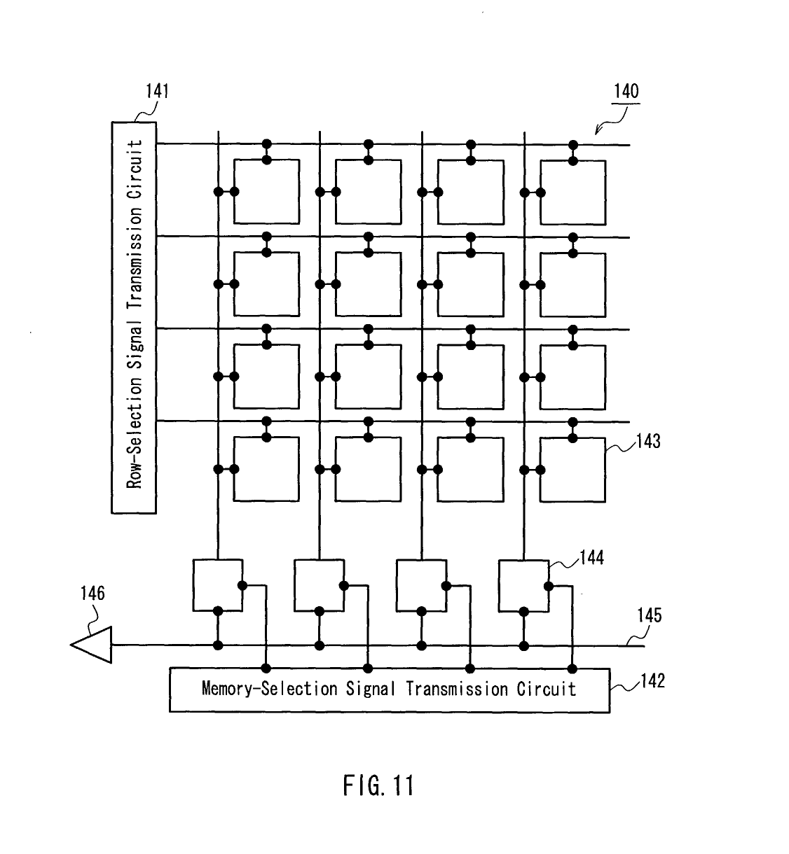

FIG. 11 is a block diagram showing a structural example of a MOS-type solid-state imaging device as a solid-state imaging device according to the fifth embodiment of the present invention. In FIG. 11, a MOS-type solid-state imaging device 140 according to the present embodiment includes a row-selection signal transmission circuit 141 for outputting a scan pulse voltage in a row direction, a memory-selection signal transmission circuit 142 for outputting a scan pulse voltage in a column direction, pixels 143 arranged in an array, memories 144 each storing a signal from the selected pixel 143 and an output amplifier 146 for amplifying a signal from the selected memory 144 and outputting it as a video signal. The row-selection signal transmission circuit 141 and the memory-selection signal transmission circuit 142 are any of the signal transmission circuits of the first to fifth embodiments.

Sixth Embodiment

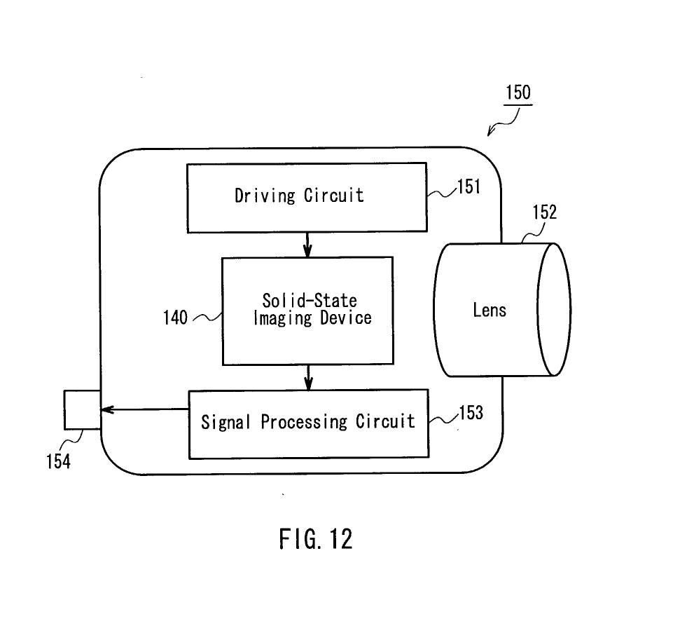

FIG. 12 is a block diagram showing a structural example of a camera according to the sixth embodiment of the present invention. In FIG. 12, a camera 150 according to the present embodiment includes a solid-state imaging device 140 according to the sixth embodiment, a driving circuit 151 for generating various drive pulses for driving the solid-state imaging device 140, a lens 152, a signal processing circuit 153 for processing a video signal outputted from the solid-state imaging device 140 in a predetermined manner and an output terminal 154 for outputting the video signal from the signal processing circuit 153.

Seventh Embodiment

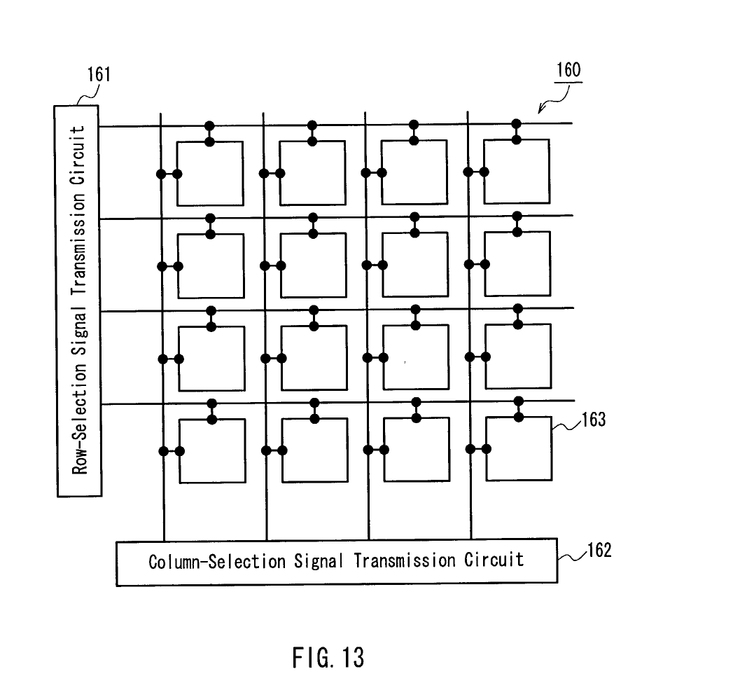

FIG. 13 is a block diagram showing a structural example of a liquid crystal display according to the seventh embodiment of the present invention. In FIG. 13, a liquid crystal display 160 according to the present embodiment includes a row-selection signal transmission circuit 161 for outputting a scan pulse voltage in a row direction, a column-selection signal transmission circuit 162 for outputting a scan pulse voltage in a column direction and pixels 163 arranged in an array. The row-selection signal transmission circuit 161 and the column-selection signal transmission circuit 162 are any of the signal transmission circuits of the first to fifth embodiments.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A signal transmission circuit comprising a plurality of stages of unit circuits from which a pulse voltage is outputted sequentially according to a drive pulse, the unit circuit of each of the plurality of stages comprising:
an output transistor whose drain receives the drive pulse and whose source outputs it as the pulse voltage;
a bootstrap capacitor connected between a gate and the source of the output transistor; and
a charge transistor for charging the bootstrap capacitor, the charge transistor having a drain connected to a power supply or a ground line, a source connected to the gate of the output transistor and a gate connected to the gate of the output transistor in the unit circuit of a preceding stage.

2. The signal transmission circuit according to claim 1, wherein the gate of the charge transistor is supplied with a start pulse in the case of the unit circuit of a first stage, and the gate of the charge transistor is connected to the gate of the output transistor in the unit circuit of a preceding stage in the case of the unit circuit of a second or later stage.

3. The signal transmission circuit according to claim 1, further comprising
a first discharge transistor whose drain is connected to one terminal of the bootstrap capacitor, and
a second discharge transistor whose drain is connected to the other terminal of the bootstrap capacitor,
wherein a common pulse voltage is applied to gates of the first and second discharge transistors.

4. The signal transmission circuit according to claim 3, wherein the common pulse voltage is supplied from the source of the output transistor in the unit circuit of a subsequent stage.

5. The signal transmission circuit according to claim 1, further comprising
a malfunction prevention transistor whose drain is connected to the gate of the output transistor in the unit circuit of a third or later stage.

6. The signal transmission circuit according to claim 1, further comprising
a malfunction prevention transistor, provided in the unit circuit of each of third and later stages, whose drain is connected to the gate of the output transistor and whose gate is connected to the source of the output transistor in the unit circuit of a stage before the preceding stage.

7. The signal transmission circuit according to claim 1, wherein, during a period in which the pulse voltage is outputted from the source of the output transistor in the unit circuit of one stage, a power supply voltage pulse that enables an operation of the charge transistor in the unit circuit of a subsequent stage and disables an operation of the charge transistor in the unit circuit of a stage after the subsequent stage is supplied to the drain of the charge transistor in the unit circuit of each of the subsequent stage and the stage after the subsequent stage.

8. The signal transmission circuit according to claim 5 or 6, wherein all the transistors are NMOS transistors, and a source of the malfunction prevention transistor is supplied with a ground potential.

9. The signal transmission circuit according to claim 5 or 6, wherein all the transistors are PMOS transistors, and a source of the malfunction prevention transistor is supplied with a power supply voltage.

10. A solid-state imaging device having a signal transmission circuit comprising a plurality of stages of unit circuits from which a scan pulse voltage is outputted sequentially according to a drive pulse, the unit circuit of each of the plurality of stages of the signal transmission circuit comprising:
an output transistor whose drain receives the drive pulse and whose source outputs it as the scan pulse voltage;
a bootstrap capacitor connected between a gate and the source of the output transistor; and
a charge transistor for charging the bootstrap capacitor, the charge transistor having a drain connected to a power supply or a ground line, a source connected to the gate of the output transistor and a gate supplied with a start pulse in the case of the unit circuit of a first stage and connected to the gate of the output transistor in the unit circuit of a preceding stage in the case of the unit circuit of a second or later stage.

11. A camera on which a solid-state imaging device having a signal transmission circuit is mounted, the signal transmission circuit comprising a plurality of stages of unit circuits from which a scan pulse voltage is outputted sequentially according to a drive pulse, the unit circuit of each of the plurality of stages of the signal transmission circuit comprising:
an output transistor whose drain receives the drive pulse and whose source outputs it as the scan pulse voltage;
a bootstrap capacitor connected between a gate and the source of the output transistor; and
a charge transistor for charging the bootstrap capacitor, the charge transistor having a drain connected to a power supply or a ground line, a source connected to the gate of the output transistor and a gate connected to the gate of the output transistor in the unit circuit of a preceding stage.

12. A liquid crystal display having a signal transmission circuit comprising a plurality of stages of unit circuits from which a scan pulse voltage is outputted sequentially according to a drive pulse, the unit circuit of each of the plurality of stages of the signal transmission circuit comprising:
an output transistor whose drain receives the drive pulse and whose source outputs it as the scan pulse voltage;
a bootstrap capacitor connected between a gate and the source of the output transistor; and
a charge transistor for charging the bootstrap capacitor, the charge transistor having a drain connected to a power supply or a ground line, a source connected to the gate of the output transistor and a gate connected to the gate of the output transistor in the unit circuit of a preceding stage.

13. A signal transmission circuit comprising a plurality of stages of unit circuits from which a pulse voltage is outputted sequentially according to a drive pulse, the unit circuit of each of the plurality of stages comprising:
an output transistor whose drain receives the drive pulse and whose source outputs it as the pulse voltage;
a bootstrap capacitor connected between a gate and the source of the output transistor;
a charge transistor for charging the bootstrap capacitor, the charge transistor having a source connected to the gate of the output transistor; and
a malfunction prevention transistor whose drain is connected to the gate of the output transistor and whose gate is connected to the source or an output driven by a source output of the output transistor in another unit circuit.

14. A signal transmission circuit comprising a plurality of stages of unit circuits from which a pulse voltage is outputted sequentially according to a drive pulse, the unit circuit of each of the plurality of stages comprising:
a first output transistor whose drain receives the drive pulse and whose source outputs it as the pulse voltage;
a first bootstrap capacitor connected between a gate and the source of the first output transistor;
a charge transistor for charging the first bootstrap capacitor, the charge transistor having a source connected to the gate of the first output transistor and a drain connected to a power supply line, a ground line or a charge pulse line; and
a second bootstrap capacitor whose one terminal is connected to a gate of the charge transistor.

15. A signal transmission circuit comprising a plurality of stages of unit circuits from which a pulse voltage is outputted sequentially according to a drive pulse, the unit circuit of each of the plurality of stages comprising:
a first output transistor whose drain receives the drive pulse and whose source outputs it as the pulse voltage;
a first bootstrap capacitor connected between a gate and the source of the first output transistor;
a first charge transistor for charging the first bootstrap capacitor, the first charge transistor having a source connected to the gate of the first output transistor and a drain connected to a power supply line, a ground line or a first charge pulse line;
a second bootstrap capacitor whose one terminal is connected to a gate of the first charge transistor and whose other terminal is connected to a source or an output driven by a source output of a second output transistor; and
a second charge transistor for charging the second bootstrap capacitor, the second charge transistor having a source connected to one terminal of the second bootstrap capacitor, a drain connected to a power supply line, a ground line or a second charge pulse line and a gate connected to a source or an output driven by a source output of a third output transistor.

16. The signal transmission circuit according to claim 15, further comprising
a first discharge transistor whose drain is connected to the source of the first charge transistor, and
a second discharge transistor whose drain is connected to the source of the second charge transistor.

17. The signal transmission circuit according to claim 16, further comprising
a third discharge transistor connected to a terminal of the first bootstrap capacitor different from the terminal connected with the first discharge transistor, and
a fourth discharge transistor connected to a terminal of the second bootstrap capacitor different from the terminal connected with the second discharge transistor.

18. The signal transmission circuit according to claim 17, wherein the third discharge transistor and the fourth discharge transistor are the same transistor.

19. The signal transmission circuit according to claim 17, wherein the drive pulse is inputted to gates of the third and fourth discharge transistors.

20. The signal transmission circuit according to claim 17, wherein gates of the second discharge transistor and the third discharge transistor of a preceding stage are supplied with the source or an output driven by a source output of the first output transistor.

21. The signal transmission circuit according to claim 15, wherein the second output transistor is an output transistor in the unit circuit of a preceding stage, and the third output transistor is an output transistor in the unit circuit of a stage before the preceding stage.

22. The signal transmission circuit according to claim 14, further comprising
a malfunction prevention transistor whose drain is connected to the gate of the first output transistor.

23. The signal transmission circuit according to claim 15, further comprising
a malfunction prevention transistor whose drain is connected to the gate of the first output transistor.

24. The signal transmission circuit according to claim 14, further comprising
a malfunction prevention transistor whose drain is connected to the gate of the first output transistor and whose gate is connected to a source or an output driven by a source output of an output transistor in the unit circuit of a stage before a preceding stage.

25. The signal transmission circuit according to claim 15, further comprising
a malfunction prevention transistor whose drain is connected to the gate of the first output transistor and whose gate is connected to a source or an output driven by a source output of an output transistor in the unit circuit of a stage before a preceding stage.

26. The signal transmission circuit according to claim 14, wherein, during a period in which the pulse voltage is outputted from the source of the first output transistor in the unit circuit of one stage, a power supply voltage pulse that enables an operation of the charge transistor in the unit circuit of a subsequent stage and disables an operation of the charge transistor in the unit circuit of a stage after the subsequent stage is supplied to the drain of the charge transistor in the unit circuit of each of the subsequent stage and the stage after the subsequent stage.

27. The signal transmission circuit according to claim 15, wherein, during a period in which the pulse voltage is outputted from the source of the first output transistor in the unit circuit of one stage, a power supply voltage pulse that enables an operation of the first charge transistor in the unit circuit of a subsequent stage and disables an operation of the first charge transistor in the unit circuit of a stage after the subsequent stage is supplied to the drain of the first charge transistor in the unit circuit of each of the subsequent stage and the stage after the subsequent stage.

28. The signal transmission circuit according to any one of claims 22 to 25, wherein all the transistors are NMOS transistors, and a source of the malfunction prevention transistor is supplied with a ground potential.

29. The signal transmission circuit according to any one of claims 22 to 25, wherein all the transistors are PMOS transistors, and a source of the malfunction prevention transistor is supplied with a power supply voltage.

30. A solid-state imaging device having a signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a charge transistor for charging the first bootstrap capacitor, the charge transistor having a source connected to the gate of the first output transistor and a drain connected to a power supply line, a ground line or a charge pulse line; and
a second bootstrap capacitor whose one terminal is connected to a gate of the charge transistor.

31. A solid-state imaging device having a signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a first charge transistor for charging the first bootstrap capacitor, the first charge transistor having a source connected to the gate of the first output transistor and a drain connected to a power supply line, a ground line or a first charge pulse line;
a second bootstrap capacitor whose one terminal is connected to a gate of the first charge transistor and whose other terminal is connected to a source or an output driven by a source output of a second output transistor; and
a second charge transistor for charging the second bootstrap capacitor, the second charge transistor having a source connected to one terminal of the second bootstrap capacitor, a drain connected to a power supply line, a ground line or a second charge pulse line and a gate connected to a source or an output driven by a source output of a third output transistor.

32. A camera on which a solid-state imaging device having a signal transmission circuit is mounted, the signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a charge transistor for charging the first bootstrap capacitor, the charge transistor having a source connected to the gate of the first output transistor and a drain connected to a power supply line, a ground line or a charge pulse line; and
a second bootstrap capacitor whose one terminal is connected to a gate of the charge transistor.

33. A camera on which a solid-state imaging device having a signal transmission circuit is mounted, the signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a first charge transistor for charging the first bootstrap capacitor, the first charge transistor having a source connected to the gate of the first output transistor and a drain connected to a power supply line, a ground line or a first charge pulse line;
a second bootstrap capacitor whose one terminal is connected to a gate of the first charge transistor and whose other terminal is connected to a source or an output driven by a source output of a second output transistor; and
a second charge transistor for charging the second bootstrap capacitor, the second charge transistor having a source connected to one terminal of the second bootstrap capacitor, a drain connected to a power supply line, a ground line or a second charge pulse line and a gate connected to a source or an output driven by a source output of a third output transistor.

34. A liquid crystal display having a signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a charge transistor for charging the first bootstrap capacitor, the charge transistor having a source connected to the gate of the first output transistor and a drain connected to a power supply line, a ground line or a charge pulse line; and
a second bootstrap capacitor whose one terminal is connected to a gate of the charge transistor.

35. A liquid crystal display having a signal transmission circuit comprising a plurality of stages of unit circuits from which a scan pulse voltage is outputted sequentially according to a drive pulse, the unit circuit of each of the plurality of stages comprising:
a first output transistor whose drain receives the drive pulse and whose source outputs it as the scan pulse voltage;
a first bootstrap capacitor connected between a gate and the source of the first output transistor;
a first charge transistor for charging the first bootstrap capacitor, the first charge transistor having a source connected to the gate of the first output transistor and a drain connected to a power supply line, a ground line or a first charge pulse line;
a second bootstrap capacitor whose one terminal is connected to a gate of the first charge transistor and whose other terminal is connected to a source or an output driven by a source output of a second output transistor; and
a second charge transistor for charging the second bootstrap capacitor, the second charge transistor having a source connected to one terminal of the second bootstrap capacitor, a drain connected to a power supply line, a ground line or a second charge pulse line and a gate connected to a source or an output driven by a source output of a third output transistor.

36. A signal transmission circuit comprising a plurality of stages of unit circuits from which a pulse voltage is outputted sequentially according to a drive pulse, the unit circuit of each of the plurality of stages comprising:
an output transistor whose drain receives the drive pulse and whose source outputs it as the pulse voltage;
a bootstrap capacitor connected between a gate and the source of the output transistor;
in the case of the unit circuit of a second or later stage, a charge transistor for charging the bootstrap capacitor, the charge transistor having a drain connected to a power supply or a ground line, a source connected to the gate of the output transistor and a gate connected to the gate of the output transistor in the unit circuit of a preceding stage; and
in the case of the unit circuit of a first stage, a charge transistor for charging the bootstrap capacitor, the charge transistor having a drain connected to a power supply or a ground line or supplied with a start pulse, a source connected to the gate of the output transistor and a gate supplied with the start pulse via one capacitor or a series capacitor including a plurality of capacitors.

37. The signal transmission circuit according to claim 36, wherein the unit circuit of the first stage comprises
a first initial charge transistor whose source or drain is connected to one terminal of the one capacitor or the series capacitor on a side of the charge transistor and whose drain or source is connected to the power supply or the ground line, respectively, and
a second initial charge transistor whose source or drain is connected to the other terminal of the one capacitor or the series capacitor and whose drain or source is connected to a ground or the power supply, respectively.

38. The signal transmission circuit according to claim 36, wherein the unit circuit of the first stage comprises
a first initial charge transistor whose source or drain is connected to one terminal of a capacitor in the series capacitor on a side of the charge transistor and whose drain or source is connected to the power supply or the ground line, respectively, and
a second initial charge transistor whose source or drain is connected to the other terminal of the capacitor in the series capacitor and whose drain or source is connected to a ground or the power supply, respectively.

39. The signal transmission circuit according to claim 38, wherein, after turning on and off the first and second initial charge transistors corresponding to the capacitor closer to the charge transistor, the input pulse turns on and off the first and second initial charge transistors corresponding to the next capacitor.

40. A camera on which a solid-state imaging device having a signal transmission circuit is mounted, the signal transmission circuit comprising a plurality of stages of unit circuits from which a scan pulse voltage is outputted sequentially according to a drive pulse, the unit circuit of each of the plurality of stages of the signal transmission circuit comprising:
an output transistor whose drain receives the drive pulse and whose source outputs it as the scan pulse voltage;
a bootstrap capacitor connected between a gate and the source of the output transistor;
in the case of the unit circuit of a second or later stage, a charge transistor for charging the bootstrap capacitor, the charge transistor having a drain connected to a power supply or a ground line, a source connected to the gate of the output transistor and a gate connected to the gate of the output transistor in the unit circuit of a preceding stage; and
in the case of the unit circuit of a first stage, a charge transistor for charging the bootstrap capacitor, the charge transistor having a drain connected to a power supply or a ground line or supplied with a start pulse, a source connected to the gate of the output transistor and a gate supplied with the start pulse via one capacitor or a series capacitor including a plurality of capacitors.

41. A liquid crystal display having a signal transmission circuit comprising a plurality of stages of unit circuits from which a scan pulse voltage is outputted sequentially according to a drive pulse, the unit circuit of each of the plurality of stages of the signal transmission circuit comprising:
an output transistor whose drain receives the drive pulse and whose source outputs it as the scan pulse voltage;
a bootstrap capacitor connected between a gate and the source of the output transistor;
in the case of the unit circuit of a second or later stage, a charge transistor for charging the bootstrap capacitor, the charge transistor having a drain connected to a power supply or a ground line, a source connected to the gate of the output transistor and a gate connected to the gate of the output transistor in the unit circuit of a preceding stage; and
in the case of the unit circuit of a first stage, a charge transistor for charging the bootstrap capacitor, the charge transistor having a drain connected to a power supply or a ground line or supplied with a start pulse, a source connected to the gate of the output transistor and a gate supplied with the start pulse via one capacitor or a series capacitor including a plurality of capacitors.
